(19) United States
(12) Patent Application Publication
(10) Pub. No.: US 2009/0066512 A1
(43) Pub. Date: Mar. 12, 2009

(54) Transponder device

(75) Inventors: Yin-Hung Tseng, Chiayi City (TW); Sheng-Chun Hsu, Tai-Tung Hsien (TW)

Correspondence Address: PILLSBURY WINTHROP SHAW PITTMAN, LLP, P.O. BOX 10500, MCLEAN, VA, 22102, US

(73) Assignee: USERSTAR INFORMATION SYSTEM CO., LTD.

(21) Appl. No.: 11/898,161

(22) Filed: Sep. 10, 2007

(51) Int. Cl. G08B 13/14

(52) U.S. Cl. 340/572.1

(57) ABSTRACT

A transponder device includes a mode selector and a transponder. The transponder, such as a radio frequency identification (RFID) tag, is coupled to the mode selector, such as a mechanical switch, and has a function that is switched selectively between enabled and disabled states upon receipt by the transponder of a wirelessly transmitted switch command when the mode selector is actuated.

### BACKGROUND OF THE INVENTION

1. Field of the Invention

This invention relates to a transponder device, more particularly to privacy risk-free transponder device.

2. Description of the Related Art

Radio Frequency Identification (RFID) tags are well known in the art. Due to low cost and small size, the RFID tag can be used for a wide variety of applications.

The RFID tag, on the other hand, poses privacy risks. For example, in retail applications, if a consumer purchased a product tagged with the RFID tag, the consumer has no way of preventing the RFID tag from being read by an unauthorized RFID reader device and is unaware that the RFID tag is being read without his or her consent.

The following are various proposed approaches to alleviate privacy risks associated with RFID tags:

The electronic product code (EPC) tag, which conforms to the EPCglobal Generation 2 standards, addresses the privacy risks by “killing”, i.e., permanently disabling, itself upon receipt of a “kill” command from a RFID reader device. This “killing” approach, however, prevents many other possibilities in retail applications of the EPC tag, many of which, e.g., product returns, require the EPC tag to remain enabled after purchase. Moreover, disabling of the EPC tag can only be confirmed by performing a read operation on the EPC tag with the use of the RFID reader device.

The clipped tag, which is disclosed in U.S. Patent Application No. 20060132313, protects privacy of a consumer by removal of a portion of a tag antenna thereof so as to shorten an operating range thereof. This provides a visible way of restricting the clipped tag from being read at long range, while still enabling the clipped tag to be read at close range for purposes such as product returns. The clipped tag, however, is still vulnerable to the above-mentioned privacy risks.

The RFID guardian, which is developed by researchers at Vrije University, generates an audible warning sound upon detection of an unauthorized RFID reader device attempting to read an RFID tag managed thereby. The RFID tag, however, is also vulnerable to the above-mentioned privacy risks.

The blocker tag, which is developed by RSA Laboratories, emits a jamming signal to prevent itself from receiving signals from an unauthorized RFID reader device. The blocker tag, however, maybe used maliciously to paralyze operation of RFID systems in retail environments.

### SUMMARY OF THE INVENTION

Therefore, the object of the present invention is to provide a transponder device that can overcome the aforesaid drawbacks of the prior art.

According to the present invention, a transponder device comprises a mode selector and a transponder. The transponder is coupled to the mode selector, and has a function that is switched selectively between enabled and disabled states upon receipt by the transponder of a wirelessly transmitted switch command when the mode selector is actuated.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a transponder device according to this invention; and

FIGS. 2 and 3 are flowcharts to illustrate steps performed by the transponder device of FIG. 1.

### DETAILED DESCRIPTION OF THE PREFERRED EMBODIMENT

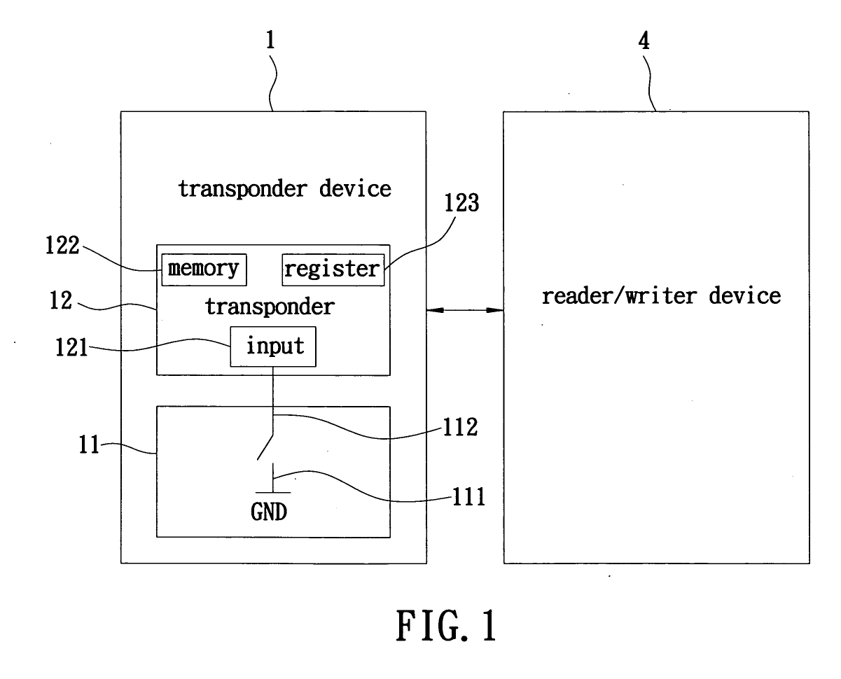

Referring to FIG. 1, the preferred embodiment of a transponder device 1 according to this invention is shown to include a mode selector 11 and a transponder 12.

The mode selector 11 is in a form of a mechanical switch, and has first and second terminals 111, 112. In this embodiment, the first terminal 111 of the mode selector 11 is connected electrically to an electrical ground (GND).

The transponder 12 has an input 121 connected electrically to the second terminal 112 of the mode selector 11, and includes a memory 122 for storing data, and a register 123 for storing a control bit. In this embodiment, the transponder 12 has a function that includes storing of data wirelessly received by the transponder 12 into the memory 122 thereof, i.e., during a write operation of a reader/writer device 4 on the transponder 12, and wirelessly transmitting the data stored in the memory 122 thereof, i.e., during a read operation of the reader/writer device 4 on the transponder 12. In an alternative embodiment, the function of the transponder 12 includes only either the storing of data wirelessly received by the transponder 12 into the memory 122 thereof, or the wirelessly transmitting of the data stored in the memory 122 thereof. Preferably, the transponder 12 is a radio frequency identification (RFID) tag.

The function of the transponder 12 is switched selectively between enabled and disabled states upon receipt by the transponder 12 of a wirelessly transmitted switch command from the reader/writer device 4 when the mode selector 11 is actuated. In this embodiment, the control bit in the register 123 of the transponder 12 is set to thereby switch the function of the transponder 12 to the enabled state, and is cleared to thereby switch the function of the transponder 12 to the disabled state. Alternatively, the control bit in the register 123 of the transponder 12 is cleared to thereby switch the function of the transponder 12 to the enabled state, and is set to thereby switch the function of the transponder 12 to the disabled state.

It is noted that, upon receipt of the switch command from the reader/writer device 4, the transponder 12 transmits either a first response which includes an indication that the function of the transponder 12 has been switched from a previous one of the enabled and disabled states to a current one of the enabled and disabled states when the mode selector 11 is actuated, i.e., switched on, or a second response, which includes an indication that the mode selector 11 is not actuated, i.e., switched off.

The transponder 12 further transmits a third response, which includes an indication of the current one of the enabled and disabled states of the function of the transponder 12, upon receipt of a request command from the reader/writer device 4 regardless of whether the mode selector 11 is actuated or not. This provides an easy way to confirm whether the function of the transponder 12 is in the enabled or disabled state without the necessity for the reader/writer device 4 to perform the read or write operation on the transponder 12.

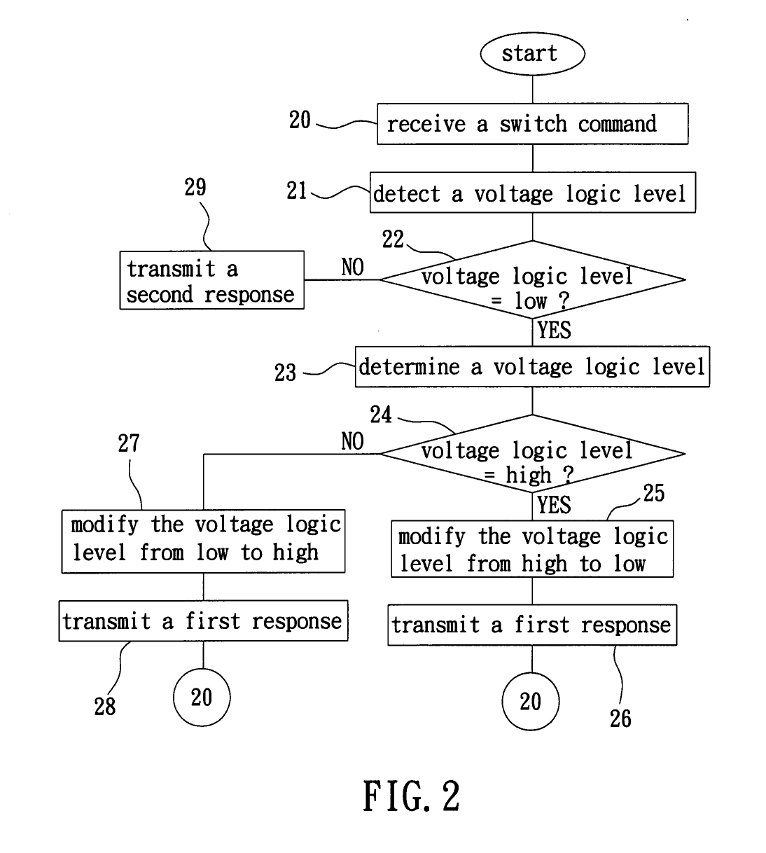

FIG. 2 illustrates the steps performed by the aforementioned transponder device 1.

In step 20, the transponder 12 wirelessly receives the switch command from the reader/writer device 4.

Instep 21, the transponder 12 detects a voltage logic level at the input 121 thereof.

In step 22, if the voltage logic level detected in step 21 is low, i.e., the mode selector 11 is switched on, the flow proceeds to step 23. Otherwise, i.e., the mode selector 11 is switch off, the flow proceeds to step 29.

In step 23, the transponder 12 determines a voltage logic level of the control bit in the register 123 thereof.

In step 24, if it is determined in step 23 that the voltage logic level of the control bit in the register 123 of the transponder 12 is high, the flow proceeds to step 25. Otherwise, the flow proceeds to step 27.

In step 25, the transponder 12 modifies the voltage logic level of the control bit in the register 123 of the transponder 12 from high to low.

In step 26, the transponder 12 transmits the first response, which includes the control bit in the register 123 thereof, to the reader/writer device 4. Thereafter, the flow goes back to step 20.

In step 27, the transponder 12 modifies the voltage logic level of the control bit in the register 123 thereof from low to high.

In step 28, the transponder 12 transmits the first response, which includes the control bit in the register thereof, to the reader/writer device 4. Thereafter, the flow goes back to step 20.

In step 29, the transponder 12 transmits the second response to the reader/writer device 4. Thereafter, the flow goes back to step 20.

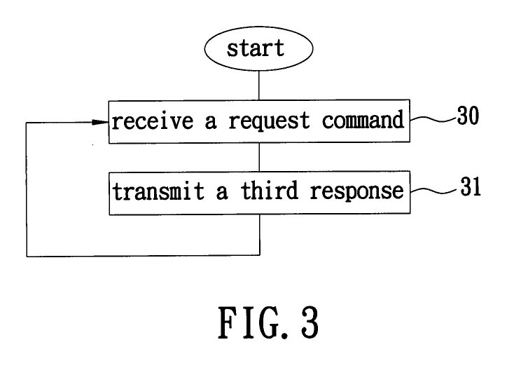

FIG. 3 illustrates further steps performed by the transponder device 1.

In step 30, the transponder 12 wirelessly receives the request command from the reader/writer device 4.

In step 31, the transponder 12 transmits the third response, which includes the control bit in the register 123 thereof, to the reader/writer device 4.

From the above, in retail applications, when it is desired to protect the privacy of a consumer upon purchase of a product tagged with the transponder device 1 of this invention, the function of the transponder 12 is first switched to the disabled state to thereby prevent the transponder 12 from being read or written by the reader/writer device 4, and the mode selector 11 is subsequently switched off to thereby prevent the function of the transponder 12 from being switched to the enabled state by the reader/writer device 4. Thereafter, when it is desired to switch the function of the transponder 12 back to the enabled state for purposes such as product returns, the mode selector 11 has to be switched back to on first.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A transponder device, comprising:
a mode selector; and
a transponder coupled to said mode selector, and having a function that is switched selectively between enabled and disabled states upon receipt by said transponder of a wirelessly transmitted switch command when said mode selector is actuated.

2. The transponder device as claimed in claim 1, wherein said transponder is a radio frequency identification (RFID) tag.

3. The transponder device as claimed in claim 1, wherein said transponder includes a memory, and said function of said transponder includes storing of data wirelessly received by said transponder into said memory.

4. The transponder device as claimed in claim 1, wherein said transponder includes a memory for storing data, and said function of said transponder includes wirelessly transmitting the data stored in said memory.

5. The transponder device as claimed in claim 1, wherein said transponder includes a memory, and said function of said transponder includes storing of data wirelessly received by said transponder into said memory and wirelessly transmitting the data stored in said memory.

6. The transponder device as claimed in claim 1, wherein said transponder transmits a response upon receipt of the switch command.

7. The transponder device as claimed in claim 6, wherein said response includes an indication that said function of said transponder has been switched from a previous one of the enabled and disabled states to a current one of the enabled and disabled states when said mode selector is actuated.

8. The transponder device as claimed in claim 6, wherein said response includes an indication that said mode selector is not actuated.

9. The transponder device as claimed in claim 1, wherein said transponder transmits a response which includes an indication of a current one of the enabled and disabled states of said function of said transponder upon receipt of a request command.

10. The transponder device as claimed in claim 1, wherein said transponder further includes a register that stores a control bit, and said function of said transponder is switched selectively between the enabled and disabled states by modifying said control bit in said register.

11. The transponder device as claimed in claim 10, wherein said control bit in said register of said transponder is set to thereby switch said function of said transponder to the enabled state, and is cleared to thereby switch said function of said transponder to the disabled state.

12. The transponder device as claimed in claim 11, wherein said transponder transmits a response upon receipt of the switch command.

13. The transponder device as claimed in claim 12, wherein said response includes said control bit in said register of said transponder when said mode selector is actuated.

14. The transponder device as claimed in claim 10, wherein said transponder transmits a response that includes said control bit in said register thereof upon receipt of a request command.

15. The transponder device as claimed in claim 1, wherein said mode selector is in a form of a mechanical switch.
